(19) United States
(12) Patent Application Publication
(10) Pub. No.: US 2024/0157183 A1
(43) Pub. Date: May 16, 2024

(54) SACRIFICIAL FIRE SHIELD FOR SHIELDING AN AIRCRAFT PART

(71) Applicant: The Boeing Company, Chicago, IL (US)

(72) Inventors: Jessica M. Ribble, Chicago, IL (US); Rachel E. Kiser, Chicago, IL (US); Brooke G. Curaudeau, Chicago, IL (US); Frank S. Portillo, Chicago, IL (US); Crystal Johnson, Chicago, IL (US)

(21) Appl. No.: 17/987,997

(22) Filed: Nov. 16, 2022

(51) Int. Cl. A62C 3/08; A62C 3/06; B32B 5/06; B32B 9/00; B32B 37/10; F02C 7/25

(52) U.S. Cl. CPC A62C 3/08; A62C 3/06; B32B 5/073; B32B 9/005; B32B 37/10; F02C 7/25; B32B 2250/02; B32B 2250/20; B32B 2260/021; B32B 2260/048; B32B 2305/72; B32B 2307/3065; B32B 2307/308; B32B 2309/105; B32B 2309/12; B32B 2315/02; B32B 2315/08; B32B 2319/00; B32B 2605/18

(57) ABSTRACT

An example sacrificial fire shield for shielding an aircraft part during a fire event includes a fiberglass layer, a ceramic fiber layer including heat-resistant fibers that is positioned on the fiberglass layer. The ceramic fiber layer and the fiberglass layer comprise a stack-up and the stack-up is pre-impregnated with rubber. The sacrificial fire shield also includes a durable outer layer comprising aramid fibers. The durable outer layer is positioned on the ceramic fiber layer to enable press curing into a form factor.

### FIELD

The present disclosure relates generally to systems and methods for providing fire protection to portions of an aircraft and, more particularly, to a sacrificial fire shield for shielding an aircraft part.

### BACKGROUND

Thermal protection fire wall systems are utilized to meet Federal Aviation Administration (FAA) aircraft Code of Federal Regulation (CFR) requirements, in which portions of aircraft (including engines, pylon, wing, and others) are required to be able to function for a period when exposed to fire, for example, in an event of an engine fire. It is intended to ensure that a flight may be safely completed in an unlikely event a fire should occur.

To be able to withstand fire for a period at 2000° F., additional fire protection can be added to portions of the aircraft, such as in a form of metallic shielding. On aircraft, however, reduced weight requirements are continuously sought. In addition, metallic shielding may have limitations of use due to structural issues and requirements of close clearances.

### SUMMARY

In one example, a sacrificial fire shield for shielding an aircraft part during a fire event is described. The sacrificial fire shield comprises a fiberglass layer, and a ceramic fiber layer including heat-resistant fibers that is positioned on the fiberglass layer. The ceramic fiber layer and the fiberglass layer comprise a stack-up and the stack-up is pre-impregnated with rubber. The sacrificial fire shield also comprises a durable outer layer comprising aramid fibers, and the durable outer layer is positioned on the ceramic fiber layer to enable press curing into a form factor.

In another example, an aircraft part is described comprising a sacrificial fire shield for shielding a portion of the aircraft part during a fire event. The sacrificial fire shield comprises a fiberglass layer and a ceramic fiber layer including heat-resistant fibers that is positioned on the fiberglass layer. The ceramic fiber layer and the fiberglass layer comprise a stack-up and the stack-up is pre-impregnated with rubber. The sacrificial fire shield also comprises a durable outer layer comprising aramid fibers, and the durable outer layer is positioned on the ceramic fiber layer to enable press curing into a form factor.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings.

FIG. 1 is a perspective view of an aircraft, according to an example implementation.

FIG. 2 illustrates a portion of internal components of an aircraft engine, according to an example implementation.

FIG. 3 illustrates a rear view of the aircraft engine, according to an example implementation.

FIG. 4 illustrates a forward side view of the forward lower bifurcation, according to an example implementation.

FIG. 5 illustrates a reverse side view of the forward lower bifurcation, according to an example implementation.

FIG. 6 illustrates another reverse side view of the forward lower bifurcation, according to an example implementation.

FIG. 7 illustrates a side view of a portion of the forward lower bifurcation including the sacrificial fire shield, according to an example implementation.

FIG. 8 is a perspective view of the sacrificial fire shield, according to an example implementation.

FIG. 9 is a side view of the sacrificial fire shield, according to an example implementation.

FIG. 10 is a side view of another example of the sacrificial fire shield, according to an example implementation.

FIG. 11 is a flowchart illustrating an example of a method for manufacturing the sacrificial fire shield, according to an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

Within examples, in areas where fire seals need additional protection, but metallic shielding is undesirable due to interference with surrounding parts, elastomeric fire shielding can be used. Elastomeric fire shielding drops temperatures for fire seals and surrounding structures in fire events and provides extended fire proof life to the fire seal during the fire event. Thus, example sacrificial fire shields are described herein that enable a light weight, fatigue resistant, pliable shielding with a low thermal conductivity.

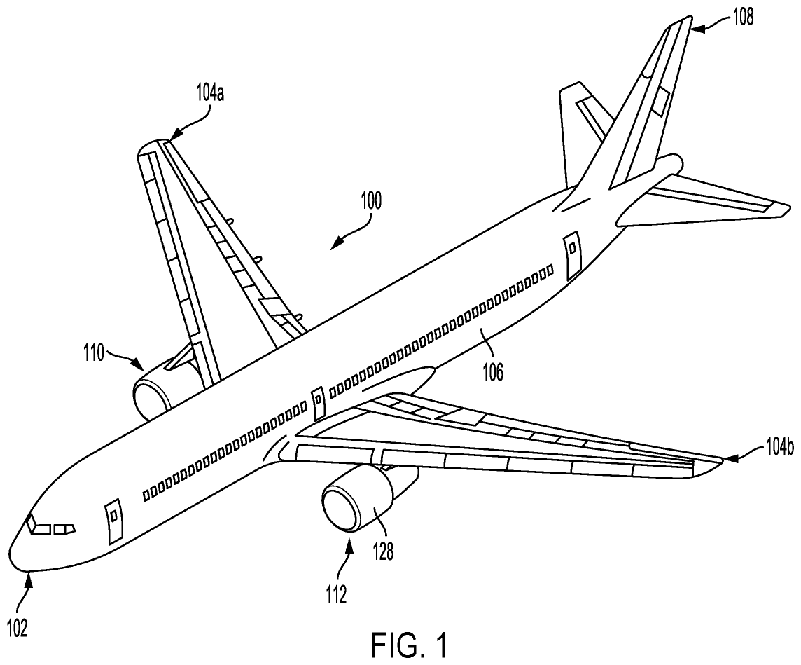

Referring now to the figures, FIG. 1 is a perspective view of an aircraft 100, according to an example implementation. The aircraft 100 includes a nose 102, wings 104a-b, a fuselage 106, and a tail 108, according to an example implementation. The aircraft 100 also includes a first engine 110 and a second engine 112 on the wings 104a-b, respectively. Each of the first engine 110 and the second engine 112 is a turbine engine in one example.

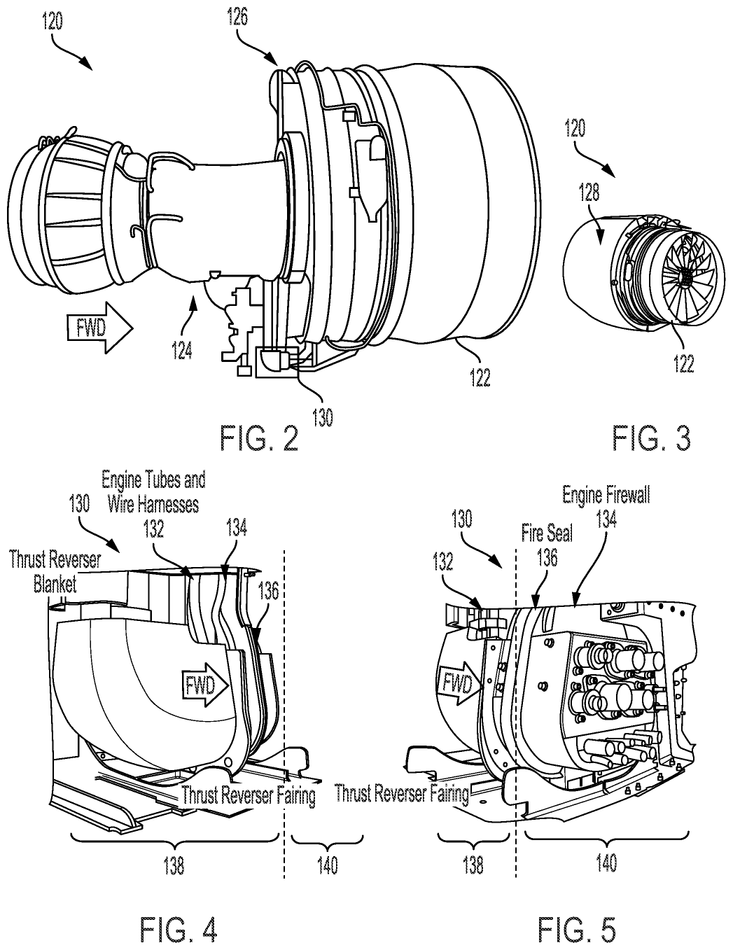

FIG. 2 illustrates a portion of internal components of an aircraft engine 120, according to an example implementation. FIG. 3 illustrates a rear view of the aircraft engine 120, according to an example implementation.

The aircraft engine 120 in FIGS. 2-3 may be representative of either or both of the first engine 110 and the second engine 112 shown in FIG. 1, for example. In FIG. 2, the aircraft engine 120 includes a fan compartment 122, and a combustor 124 separated by a firewall 126. Air enters the aircraft engine 120 and is compressed and delivered into the combustor 124 where the compressed air is mixed with fuel and ignited to generate a high-speed exhaust gas flow. The high-speed exhaust gas flow expands through the combustor 124 to drive the fan compartment 122. The aircraft engine 120 is surrounded by a nacelle structure 128 (shown in FIG. 1 and FIG. 3) that includes housing surrounding the fan compartment 122 and an aft nacelle surrounding the core compartment combustor 124. Thus, the nacelle structure is shown enclosing components of the aircraft engine 120. An upper and lower bifurcation is commonly provided along a centerline of the aircraft engine 120 to allow engine systems to pass between the fan compartment 122 and the core compartment combustor 124. In FIG. 2, a portion of the aircraft engine 120 including a forward lower bifurcation 130 is shown.

FIG. 4 illustrates a forward side view of the forward lower bifurcation 130, according to an example implementation. FIG. 5 illustrates a reverse side view of the forward lower bifurcation 130, according to an example implementation. The forward lower bifurcation 130 represents an aircraft part, and includes various tubes and wire harnesses 132 as well as an engine firewall 134 to separate a feedthrough conduit of the core compartment 124 from the fan compartment 122. In addition, a fire seal 136 is included for shielding a portion of the aircraft part during a fire event.

FIG. 4 and FIG. 5 include a dotted line illustration to conceptually divide the forward lower bifurcation 130 into two areas including a fire zone area 138 and a propulsion area 140. Fire protection systems (including the fire seal 136 and a sacrificial fire shield described below) are included between the fire zone area 138 and the propulsion area 140.

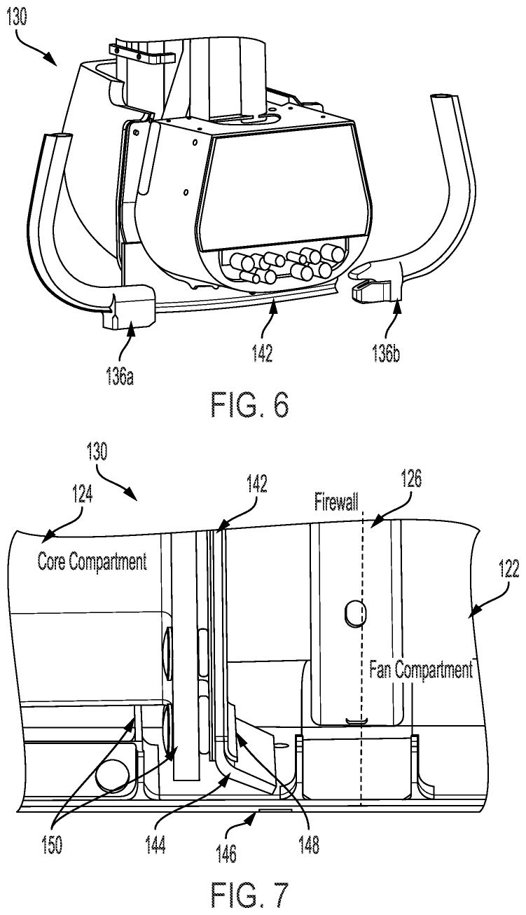

FIG. 6 illustrates another reverse side view of the forward lower bifurcation 130, according to an example implementation. In FIG. 6, the fire seal 136 is shown as two parts (e.g., a fire seal-female 136a and a fire seal-male 136b). In addition, a sacrificial fire shield 142 is included for shielding a portion of the aircraft part during a fire event. The sacrificial fire shield 142 is positioned within the forward lower bifurcation 130 and between the core compartment 124 and the fan compartment 122. A portion of the forward lower bifurcation 130 to which the sacrificial fire shield 142 is attached and contacts is considered the fire zone area 138. The sacrificial fire shield 142 is bolted to a structure of the forward lower bifurcation 130.

FIG. 7 illustrates a side view of a portion of the forward lower bifurcation 130 including the sacrificial fire shield 142, according to an example implementation. The sacrificial fire shield 142 is shown bolted to a portion of the core compartment 124 feedthrough area, and an end of the sacrificial fire shield 142 includes a bent portion 144 contacting an interior wall 146 of the nacelle structure 128. A flame shield retainer 148 is included on a side of the sacrificial fire shield 142 not exposed to fire to provide structural support for the sacrificial fire shield 142. The flame shield retainer 148 is a metal part, such as comprised of steel, for example. FIG. 7 further illustrates additional flame discouragers 150 in the fire zone area 138 to assist with fire protection.

In operation, the sacrificial fire shield 142 contains the fire in the fire zone area 138, and will burn away between about five minutes to about fifteen minutes to enhance a lifespan for the firewall 126. Such operation, for example, allows for certification of fire seal configurations within the aircraft engine 120. Thus, including the sacrificial fire shield 142 in front of a propulsion area 140, such as in front of a thrust reverser forward lower bifurcation and thrust reverser forward upper horizontal section, enables the firewall 126 to contain the fire in the fire zone area 138.

The sacrificial fire shield 142 is a flexible silicone component that creates a tortuous path and absorb most of any heat energy from fire before the firewall 126 is exposed to the fire. Within examples, the sacrificial fire shield 142 is designed to burn away during a fifteen minute fire test, which ensures residual flame is not present post-test to enable for certification of fire seal configurations. Thus, while the sacrificial fire shield 142 burns away and is sacrificed, the firewall 126 remains intact and the fire event is contained to one compartment of the aircraft engine 120 rather than traveling forward to the fan compartment 122. As such, any flames from a fire event are not allowed to pass through to the firewall 126 during certification testing. Using the sacrificial fire shield 142 reduces certification costs in many examples.

In the example shown in FIG. 7, the bent portion 144 of the sacrificial fire shield 142 gives the sacrificial fire shield 142 a direction to deflect when in contact with a surrounding structure.

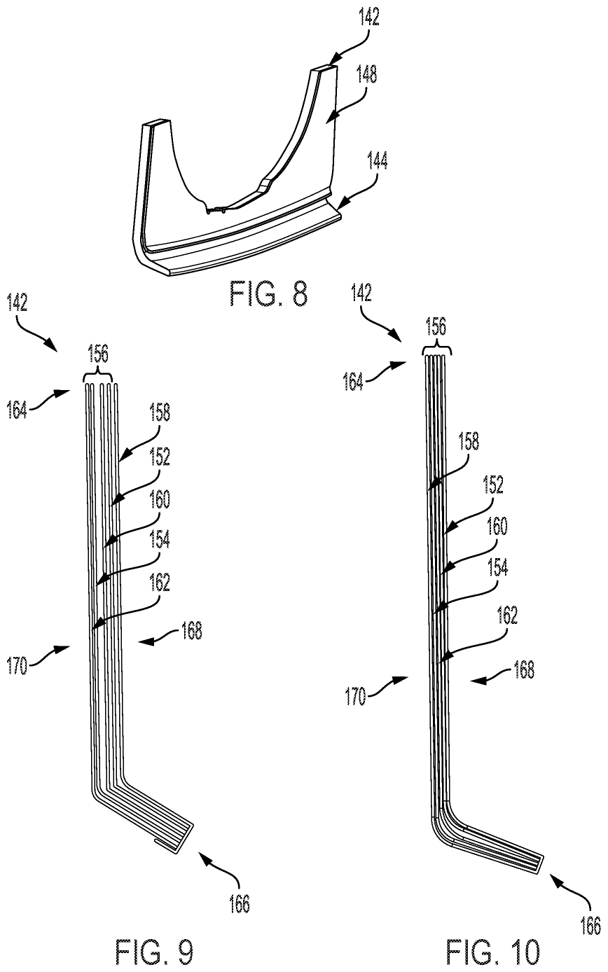

FIG. 8 is a perspective view of the sacrificial fire shield 142, according to an example implementation. The sacrificial fire shield 142 includes a curved opening for fitting around the conduit feedthrough of the forward lower bifurcation 130, for example.

FIG. 9 is a side view of the sacrificial fire shield 142, according to an example implementation. The sacrificial fire shield 142 includes a fiberglass layer 152, a ceramic fiber layer 154 including heat-resistant fibers that is positioned on the fiberglass layer 152 and the ceramic fiber layer 154 and the fiberglass layer 152 comprise a stack-up 156 that is pre-impregnated with rubber. The sacrificial fire shield 142 further includes a durable outer layer 158 comprising aramid fibers, and the durable outer layer 158 is positioned on the ceramic fiber layer 154 to enable press curing into a form factor.

In the example shown in FIG. 9, the fiberglass layer 152 includes multiple plies, such as additional fiberglass plies 160 and 162, to aid in stiffness of the sacrificial fire shield 142. In addition, the ceramic fiber layer 154 is a single layer to increase fire resistance of the sacrificial fire shield 142. The ceramic fiber layer 154 extends a full length of the fiberglass layer 152.

The durable outer layer 158 is shown to extend around an exterior of the sacrificial fire shield 142 on one side of the sacrificial fire shield 142. For example, the durable outer layer 158 does not fully surround the stack-up 156, but rather, the durable outer layer 158 is positioned over the fiberglass layer 152 on a side of the sacrificial fire shield 142 where the sacrificial fire shield 142 contacts another surface and is exposed to fire. Thus, the durable outer layer 158 is not on a backside of the sacrificial fire shield 142, in one example. For instance, the durable outer layer 158 covers the sacrificial fire shield 142 on a side that interfaces with the flame shield retainer 148, as shown in FIG. 8.

In addition, the sacrificial fire shield 142 has a first end 164 and a second end 166 opposite the first end 164, as well as a first side 168 in contact with another surface and a second side 170 opposite the first side 168. In this example, the durable outer layer 158 covers the first end 164, the second end 166, and the first side 168.

In other examples, the durable outer layer 158 is positioned to cover only one of the ends, such as the second end 166 of the bent portion, as shown in FIG. 9. In still other examples, the durable outer layer 158 extends around an entirety of the sacrificial fire shield 142.

FIG. 10 is a side view of another example of the sacrificial fire shield 142, according to an example implementation. The sacrificial fire shield 142 includes the fiberglass layer 152 configured as multiple plies, such as additional fiberglass plies 160 and 162, the ceramic fiber layer 154 including heat-resistant fibers that is positioned on the fiberglass ply 162 and the ceramic fiber layer 154 and the fiberglass layer 152 comprise a stack-up 156 that is pre-impregnated with rubber. The sacrificial fire shield 142 further includes the durable outer layer 158 comprising aramid fibers, and the durable outer layer 158 is positioned on the ceramic fiber layer 154 to enable press curing into a form factor. In the example shown in FIG. 10, the durable outer layer 158 is positioned to cover the second side 170 and extend around the second end 166 of the sacrificial fire shield 142. The first side 168 is a backside in this example, and is not in contact with any surface, and thus, does not require the durable outer layer 158.

Many materials many be used for the different layers of the sacrificial fire shield 142. Some examples are described below.

The fiberglass layer 152 add stiffness to the sacrificial fire shield 142, and the number of plies used may be increased to increase the stiffness. The fiberglass layer 152 has a decomposition temperature of 730° C. (1346° F.), in one example.

The ceramic fiber layer 154 provide fire durability for the sacrificial fire shield 142. The ceramic fiber layer 154 is a flameproof portion acting as a deterrent for burning during an early portion of a fire test. The ceramic fiber layer 154 includes composite fibers, such as in ceramic and metal matrix composites, in one example. The ceramic fiber layer 154 has a decomposition temperature of 1800° C. (3272° F.), in one example.

The durable outer layer 158 includes a composition of aramid fibers, lyocell fibers, and modacrylic fibers, in one example. In one instance, the composition is 34% aramid, 33% lyocell, 31% modacrylic and 2% antistatic fibers. The durable outer layer 158 acts as a wear surface, to limit damage to the sacrificial fire shield 142 during collisions with other parts. The durable outer layer 158 has a decomposition temperature of 250° C. (482° F.), in one example.

The sacrificial fire shield 142 has a total thickness of (i) the ceramic fiber layer 154, (ii) the fiberglass layer 152, and (iii) the durable outer layer 158 in a range of about 0.06 inches to about 0.14 inches. A thickness of the sacrificial fire shield 142 varies based on a number of plies used in the fiberglass layer 152 due to a desired stiffness.

Within examples, the ceramic fiber layer 154, the fiberglass layer 152, and the durable outer layer 158 include flexibility to enable deformation of the sacrificial fire shield 142. For example, the bent portion 144 helps with deformation characteristics to give a known deflection path for the sacrificial fire shield 142. In addition, the stack-up 156 is pre-impregnated with rubber pieces so as to suspend the stack-up 156 in elastomeric material for further flexibility properties.

The sacrificial fire shield 142 includes plies positioned in a specific order due to the material properties of each ply. For instance, the ceramic fiber layer 154 is positioned directly underneath the durable outer layer 158 on a fire adjacent side since the ceramic fiber layer 154 is most heat resistant and protects the fiberglass layer 152 underneath the ceramic fiber layer 154. The ceramic fiber layer 154 fully covers the fiberglass layer 152 for best protection, however, full coverage may not be necessary in all applications.

In operation, the sacrificial fire shield 142 is allowed to be consumed by fire thereby absorbing heat energy such that when directly exposed to fire having a temperature of at least 2000° F., the sacrificial fire shield 142 absorbs a majority of the heat energy from the fire and has a planned failure point before the fire is completed to aid in reduction of continued burning. Thus, the sacrificial fire shield 142 functions as a flame shield and burns away so that no residual burning or left over silicone remains. The structure and form of the sacrificial fire shield 142 makes a complex path or full barrier for flames trying to attack a fire seals.

Within the examples shown in FIGS. 2-7, the sacrificial fire shield 142 is used within a portion of the aircraft engine 120. In other examples, the sacrificial fire shield 142 is used within any propulsion system that is exposed to a fire zone, and the sacrificial fire shield 142 is positioned between the propulsion system and the fire zone. In still further examples, the sacrificial fire shield 142 is used in any aircraft fire wall system, such as to provide shielding for a nacelle inlet, a nacelle fan cowl, a nacelle fan duct, a pylon, a wing, and an auxiliary power unit (APU).

Within examples, the sacrificial fire shield 142 has shown to be operational and fully destructed by a 15 minute mark on fire proof seals. However, in other examples, the sacrificial fire shield 142 can be composed of less plies and designed to be destructed by a 5 minute mark for a fire resistant seal.

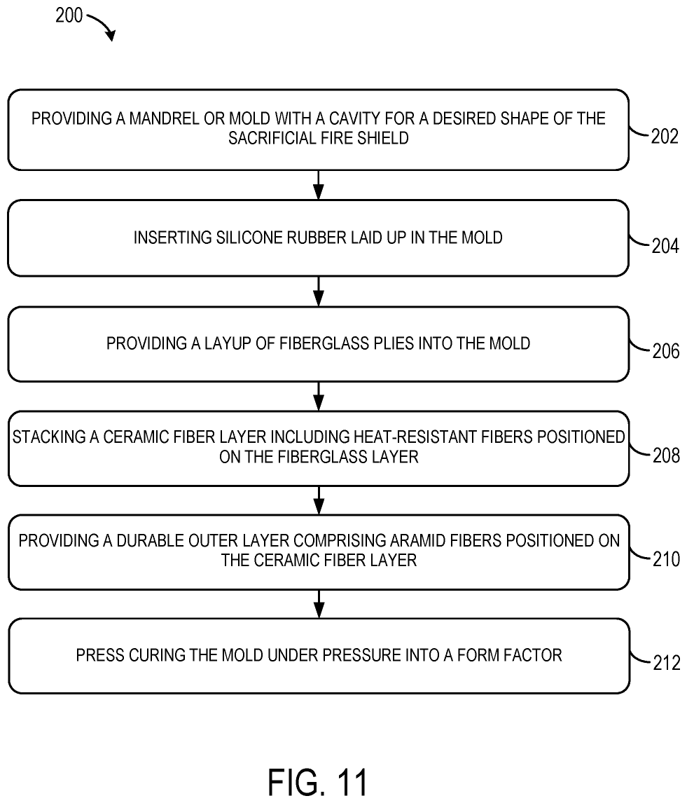

FIG. 11 is a flowchart illustrating an example of a method 200 for manufacturing the sacrificial fire shield 142, according to an example implementation. Method 200 shown in FIG. 11 presents an example of a method that could be used to manufacture the sacrificial fire shield 142 shown in FIGS. 6-10, for example. Further, devices or systems may be used or configured to perform logical functions presented in FIG. 11.

It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 202, the method 200 includes providing a mandrel or mold with a cavity for a desired shape of the sacrificial fire shield.

At block 204, the method 200 includes inserting silicone rubber laid up in the mold.

At block 206, the method 200 includes providing a layup of fiberglass plies into the mold.

At block 208, the method 200 includes stacking a ceramic fiber layer including heat-resistant fibers positioned on the fiberglass layer.

At block 210, the method 200 includes providing a durable outer layer comprising aramid fibers positioned on the ceramic fiber layer.

At block 212, the method includes press curing the mold under pressure into a form factor.

By the term “substantially” and “about” used herein, it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

What is claimed is:

1. A sacrificial fire shield for shielding an aircraft part during a fire event comprising:
a fiberglass layer;
a ceramic fiber layer including heat-resistant fibers that is positioned on the fiberglass layer, wherein the ceramic fiber layer and the fiberglass layer comprise a stack-up and the stack-up is pre-impregnated with rubber; and
a durable outer layer comprising aramid fibers, wherein the durable outer layer is positioned on the ceramic fiber layer to enable press curing into a form factor.

2. The sacrificial fire shield of claim 1, wherein the fiberglass layer comprises multiple plies to aid in stiffness of the sacrificial fire shield.

3. The sacrificial fire shield of claim 1, wherein the ceramic fiber layer comprises a single layer to increase fire resistance of the sacrificial fire shield.

4. The sacrificial fire shield of claim 1, wherein the ceramic fiber layer extends a full length of the fiberglass layer.

5. The sacrificial fire shield of claim 1, wherein the sacrificial fire shield has a first end and a second end opposite the first end, as well as a first side in contact with another surface and a second side opposite the first side, wherein the durable outer layer covers the first end, the second end, and the first side.

6. The sacrificial fire shield of claim 1, wherein the durable outer layer further comprises lyocell fibers and modacrylic fibers.

7. The sacrificial fire shield of claim 1, wherein the ceramic fiber layer has a decomposition temperature of 1800° C.

8. The sacrificial fire shield of claim 1, wherein the fiberglass layer has a decomposition temperature of 730° C.

9. The sacrificial fire shield of claim 1, wherein the durable outer layer has a decomposition temperature of 250° C.

10. The sacrificial fire shield of claim 1, wherein a total thickness of (i) the ceramic fiber layer, (ii) the fiberglass layer, and (iii) the durable outer layer is in a range of about 0.06 inches to about 0.14 inches.

11. The sacrificial fire shield of claim 1, wherein the sacrificial fire shield is allowed to be consumed by fire thereby absorbing heat energy such that when directly exposed to fire having a temperature of at least 2000° F., the sacrificial fire shield adsorbs a majority of the heat energy from the fire and has a planned failure point before the fire is completed to aid in reduction of continued burning.

12. An aircraft part, comprising:
a sacrificial fire shield for shielding a portion of the aircraft part during a fire event, the sacrificial fire shield comprising:
a fiberglass layer;
a ceramic fiber layer including heat-resistant fibers that is positioned on the fiberglass layer, wherein the ceramic fiber layer and the fiberglass layer comprise a stack-up and the stack-up is pre-impregnated with rubber; and
a durable outer layer comprising aramid fibers, wherein the durable outer layer is positioned on the ceramic fiber layer to enable press curing into a form factor.

13. The aircraft part of claim 12, wherein the ceramic fiber layer extends a full length of the fiberglass layer.

14. The aircraft part of claim 12, further comprising:
a propulsion system exposed to a fire zone, wherein the sacrificial fire shield is positioned between the propulsion system and the fire zone.

15. The aircraft part of claim 14, further comprising a nacelle structure enclosing the propulsion system.

16. The aircraft part of claim 15, wherein an end of the sacrificial fire shield includes a bent portion contacting an interior wall of the nacelle structure.

17. The aircraft part of claim 12, wherein the durable outer layer further comprises lyocell fibers and modacrylic fibers.

18. The aircraft part of claim 12, wherein a total thickness of (i) the ceramic fiber layer, (ii) the fiberglass layer, and (iii) the durable outer layer is in a range of about 0.06 inches to about 0.14 inches.

19. The aircraft part of claim 12, wherein the ceramic fiber layer, the fiberglass layer, and the durable outer layer include flexibility to enable deformation of the sacrificial fire shield.

20. The aircraft part of claim 12, wherein the sacrificial fire shield is allowed to be consumed by fire thereby absorbing heat energy such that when directly exposed to fire having a temperature of at least 2000° F., the sacrificial fire shield adsorbs a majority of the heat energy from the fire and has a planned failure point before the fire is completed to aid in reduction of continued burning.
